(19) United States
(12) Patent Application Publication
(10) Pub. No.: US 2019/0208852 A1
(43) Pub. Date: Jul. 11, 2019

(54) Intelligent LED lighted bicycle helmet

(71) Applicants: Jiayuan Zheng, Shenzhen (CN); Haitao Cao, Shenzhen (CN)

(72) Inventors: Jiayuan Zheng, Shenzhen (CN); Haitao Cao, Shenzhen (CN)

(21) Appl. No.: 16/357,325

(22) Filed: Mar. 19, 2019

(51) Int. Cl. A42B 3/04; F21L 4/02; F21L 4/08; B60Q 1/26

(52) U.S. Cl. CPC A42B 3/0453; F21L 4/02; F21Y 2115/10; B60Q 1/2676; A42B 3/044; F21L 4/08

(57) ABSTRACT

An intelligent bicycle helmet apparatus is provided with a front left light assembly including front left turn signal lights and front left indicators; a front right light assembly including front right turn signal lights and front right indicators; a rear light assembly including indicators; left and right light assemblies; rear left turn signal lights; rear left brake lights; rear right turn signal lights; rear right brake lights; a LED device including the rear light assembly, the rear left and right turn signal lights, the rear left and right brake lights, the front left turn signal lights, the front left and right indicators, and the front right turn signal lights; a MCU electrically connected to the LED device; buzzers electrically connected to the MCU; a speed indicator electrically connected to the

MCU; a head angle indicator electrically connected to the MCU; and a rechargeable battery.

### BACKGROUND OF THE INVENTION

### 1. Field of the Invention

The invention relates to bicycle helmets and more particularly to an intelligent light-emitting diode (LED) lighted bicycle helmet.

### 2. Description of Related Art

Bicycle helmets can reduce injury in the event of a collision or accident, and a suitable helmet is legally required of riders in many jurisdictions. A conventional bicycle helmet comprises a shell, i.e., the hard outer surface, for absorbing shock in the event of a collision or accident; a pad member mounted on an inner surface of the shell also for absorbing shock in the event of a collision or accident; two chin straps and a buckle for securing the shell to the head of a cyclist; a visor mounted on a front end of the shell to give protection from strong light from the sun, the visor being adjustable or not; a plurality of apertures through the shell for ventilation purpose; and a knob on a rear of the shell for adjusting size of the shell in order to accommodate the head of the cyclist; and a sweat absorbing cloth provided on the pad member.

It is suggested that not only cyclists of racing bicycles should wear helmets but also cyclists of ordinary bicycles for safety purpose.

However, typical bicycles are not equipped with lights, a speed indicator and a head angle indicator. Thus, the need for improvement still exists.

### SUMMARY OF THE INVENTION

It is therefore one object of the invention to provide a bicycle helmet apparatus, comprising a helmet; a front left light assembly provided on a left side of the helmet and including a plurality of front left turn signal lights and a plurality of front left indicators; a front right light assembly provided on a right side of the helmet and including a plurality of front right turn signal lights and a plurality of front right indicators; a rear light assembly provided on an upper portion of a rear end of the helmet and including a plurality of indicators; a left light assembly provided on a left side of a lower portion of the rear end of the helmet; a right light assembly provided on a right side of the lower portion of the rear end of the helmet; a plurality of rear left turn signal lights provided on an upper portion of the left light assembly; a plurality of rear left brake lights provided on a lower portion of the left light assembly; a plurality of rear right turn signal lights provided on an upper portion of the right light assembly; a plurality of rear right brake lights provided on a lower portion of the right light assembly; a LED device including the indicators, the rear left turn signal lights, the rear left brake lights, the rear right turn signal lights, the rear right brake lights, the front left turn signal lights, the front left indicators, the front right turn signal lights, and the front right indicators; a microcontroller unit (MCU) provided in the helmet and electrically connected to the LED device; a power supply electrically connected to the MCU and including a rechargeable battery; left and right buzzers electrically connected to the MCU; a speed indicator electrically connected to the MCU; and a head angle indicator electrically connected to the MCU.

Preferably, further comprises a charging socket provided on the rear end of the helmet and electrically connected to the rechargeable battery.

Preferably, the left and right buzzers are provided on the rear end of the helmet.

Preferably, further comprises a rear shell component provided on the rear end of the helmet and left and right shell components provided on left and right sides of the helmet respectively.

Preferably, further comprises a pad member provided on an inner surface of the helmet, two chin straps extending from the right and left sides of the helmet respectively, a female fastener provided at an end of one chip strap, and a male fastener provided at an end of the other chip strap and configured to insert into the female fastener to secure the chin straps together.

Preferably, the helmet is streamlined.

Preferably, the rear left turn signal lights, the rear right turn signal lights, the front left turn signal lights, and the front right turn signal lights are formed of yellow LEDs; the indicators, the rear left brake lights, and the rear right brake lights are formed of red LEDs; and the front left indicators and the front right indicators are formed of white LEDs respectively.

The invention has the following advantages and benefits in comparison with the conventional art: the bicycle helmet is intelligent by activating both the speed indicator and the head angle indicator to measure a speed of the bicycle and a pivot angle of the handlebar respectively. Further, the corresponding changes in both the speed indicator and the head angle indicator are converted into signals and sent to the MCU. Furthermore, the MCU processes the signals to light or flash components of the LED device for warning pedestrians and other vehicles in riding.

The above and other objects, features and advantages of the invention will become apparent from the following detailed description taken with the accompanying drawings.

### BRIEF DESCRIPTION OF THE DRAWINGS

FIG. 1 is a perspective view of a bicycle helmet apparatus according to the invention;

FIG. 2 is a right side view of FIG. 1;

FIG. 3 is a rear view of FIG. 1; and

FIG. 4 is a block diagram of the bicycle helmet apparatus.

### DETAILED DESCRIPTION OF THE INVENTION

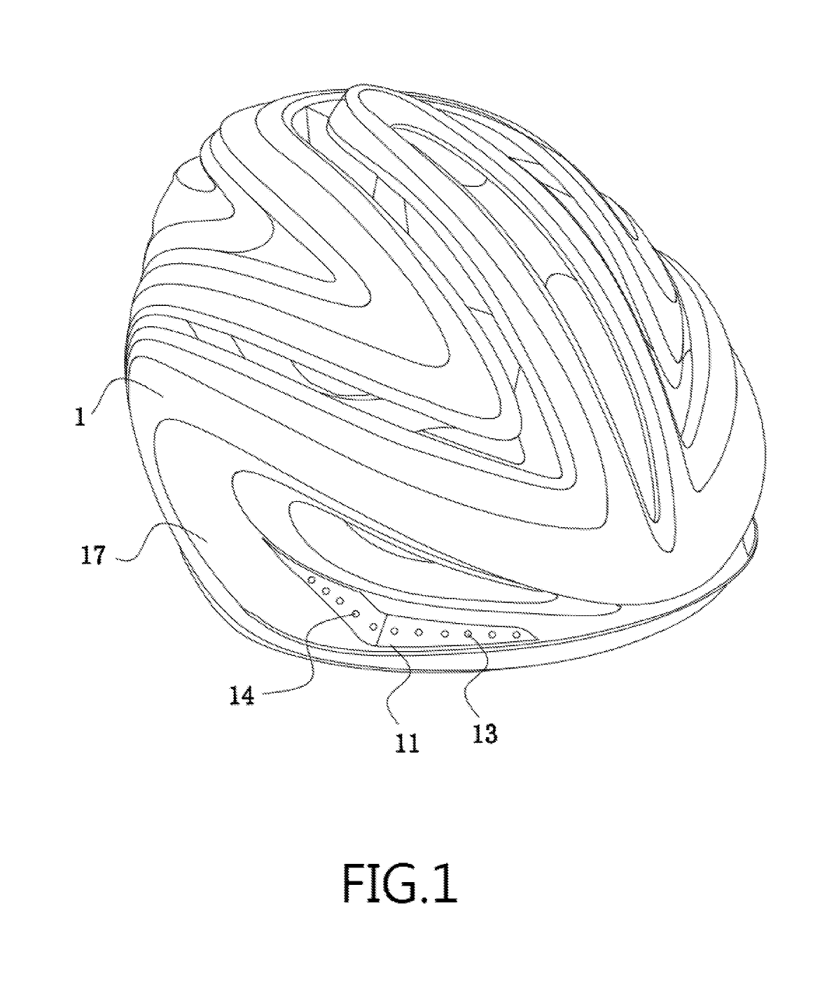

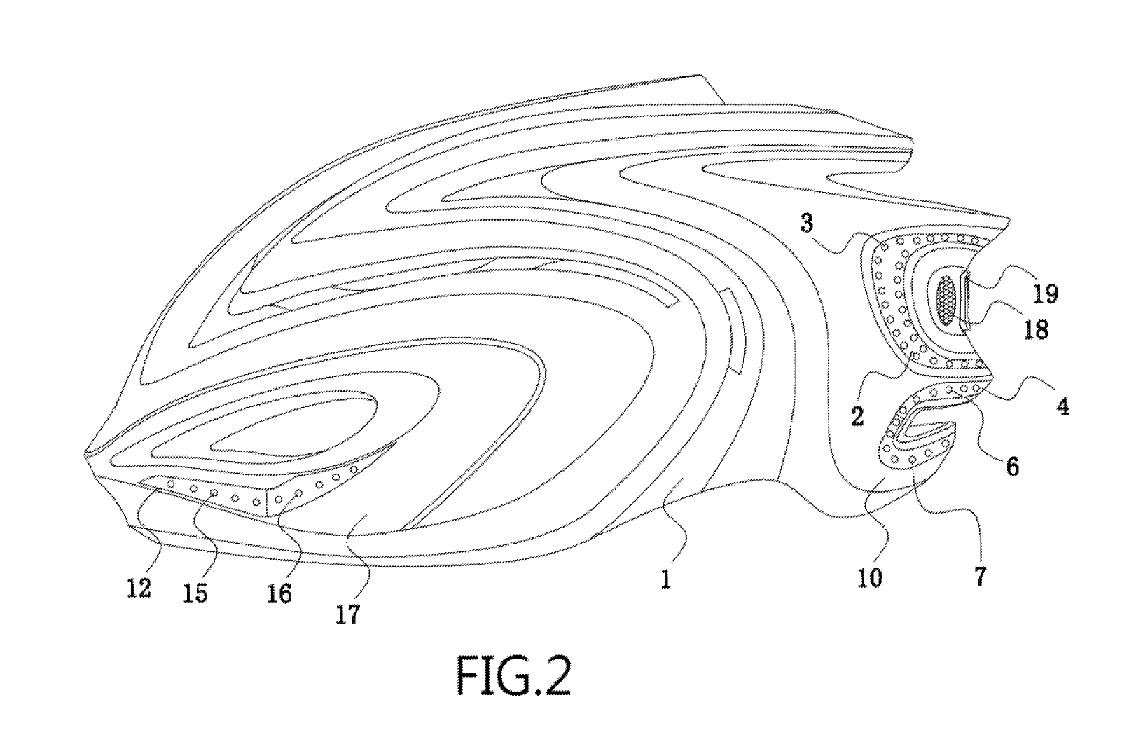

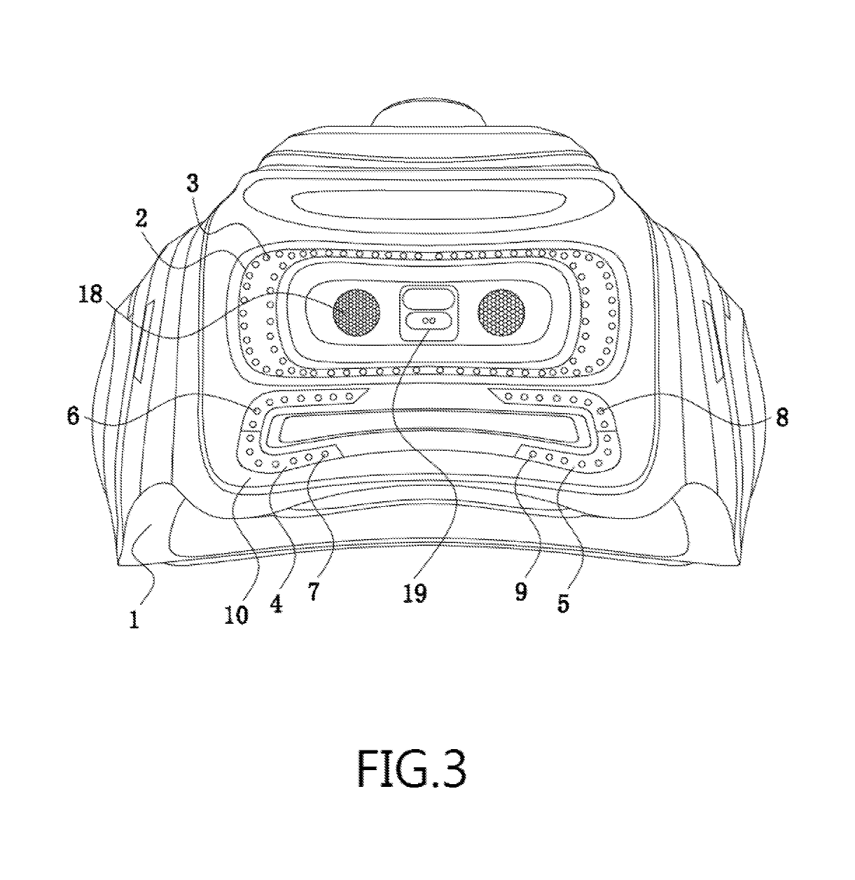

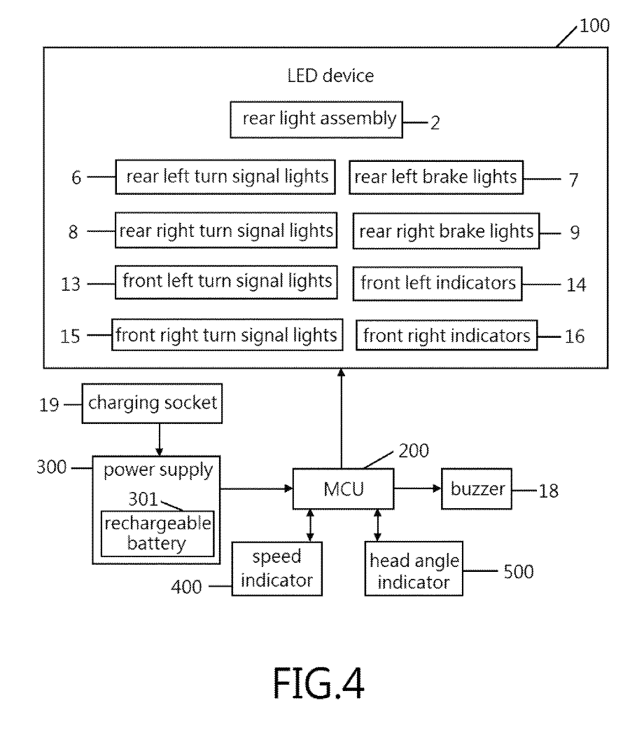

Referring to FIGS. 1 to 4, a bicycle helmet apparatus in accordance with the invention comprises the following components as discussed in detail below.

A rear light assembly 2 is provided on an upper portion of a rear end of a helmet 1 and includes a plurality of indicators 3 arranged as a closed loop. A left light assembly 4 is provided on a left side of a lower portion of the rear end of the bicycle helmet 1. A right light assembly 5 is provided on a right side of the lower portion of the rear end of the bicycle helmet 1. A plurality of rear left turn signal lights 6 are provided on an upper portion of the left light assembly 4. A plurality of rear left brake lights 7 are provided on a lower portion of the left light assembly 4. A plurality of rear right turn signal lights 8 are provided on an upper portion of the right light assembly 5. A plurality of rear right brake lights 9 are provided on a lower portion of the right light assembly 5. A front left light assembly 11 is provided on a left side of the bicycle helmet 1 and includes a plurality of front left turn signal lights 13 and a plurality of front left indicators 14. A front right light assembly 12 is provided on a right side of the bicycle helmet 1 and includes a plurality of front right turn signal lights 15 and a plurality of front right indicators 16. A LED device 100 is comprised of the rear light assembly 2 (i.e., the indicators 3), the rear left turn signal lights 6, the rear left brake lights 7, the rear right turn signal lights 8, the rear right brake lights 9, the front left turn signal lights 13, the front left indicators 14, the front right turn signal lights 15, and the front right indicators 16.

In the bicycle helmet 1, there is provided a microcontroller unit (MCU) 200 electrically connected to the LED device 100. The MCU 200 has a part number STM8S103. A power supply 300 is electrically connected to the MCU 200 and includes a rechargeable battery 301. Left and right buzzers 18 are provided in an area surrounded by the indicators 3 and electrically connected to the MCU 200. A speed indicator 400 is electrically connected to the MCU 200 and has a part number Lis3dhtr. A head angle indicator 500 is electrically connected to the MCU 200 and has a part number MPU6887. A charging socket 19 is provided between the buzzers 18 to facilitate charging and electrically connected to the rechargeable battery 301.

A rear shell component 10 is provided on the rear end of the bicycle helmet 1 and left and right shell components 17 are provided on left and right sides of the bicycle helmet 1 respectively all for the protection of bicycle helmet LED device 100.

A pad member (not shown) is provided on an inner surface of the bicycle helmet 1 for cushioning purpose. Two chin straps (not shown) extend from the right and left sides of the bicycle helmet 1 respectively. A male fastener (not shown) is provided at an end of one chip strap and a female fastener (not shown) is provided at an end of the other chip strap. The male fastener is inserted into the female fastener to secure the chin straps together.

Preferably, the bicycle helmet 1 is streamlined so as to be aesthetic and minimize resistance to motion through the air.

Preferably, the rear left turn signal lights 6, the rear right turn signal lights 8, the front left turn signal lights 13, and the front right turn signal lights 15 are formed of yellow LEDs; and the indicators 3, the rear left brake lights 7, and the rear right brake lights 9 are formed of red LEDs; and the front left indicators 14 and the front right indicators 16 are formed of white LEDs respectively for distinction.

The MCU 200 may operate in one of lighting mode (i.e., riding mode), slow flashing mode, and fast flashing mode as detailed below.

In the lighting mode, the indicators 3, the front left indicators 14, and the front right indicators 16 are lit; in the slow flashing mode, the indicators 3, the front left indicators 14, and the front right indicators 16 are slowly flashed; and in the fast flashing mode, the indicators 3, the front left indicators 14, and the front right indicators 16 are quickly flashed.

The lighting mode with the indicators 3, the front left indicators 14, and the front right indicators 16 being lit is performed for warning pedestrians and other vehicles in riding.

For turning the stem of the bicycle to left, a cyclist may turn his or her head 15 to 30 degrees to the left and slow the bicycle prior to turning his or her head to a forward direction. And in turn, both the speed indicator 400 and the head angle indicator 500 activate to show corresponding changes. Further, both the rear left turn signal lights 6 and the front right turn signal lights 15 are slowly flashed for warning purpose. After 30 seconds, the pedaling bicycle returns to the riding mode.

For turning the stem of the bicycle to right, the cyclist may turn his or her head 15 to 30 degrees to the right and slow the bicycle prior to turning his or her head to a forward direction. And in turn, both the speed indicator 400 and the head angle indicator 500 activate to show corresponding changes. Further, both the rear right turn signal lights 8 and the front left turn signal lights 13 are slowly flashed for warning purpose. After 30 seconds, the pedaling bicycle returns to the riding mode.

After the bicycle has been braked, both the speed indicator 400 and the head angle indicator 500 activate to show corresponding changes. Further, the indicators 3, the rear left brake lights 7, and the rear right brake lights 9 are lit for warning purpose. After 2 seconds, the pedaling bicycle returns to the riding mode.

It is envisaged by the invention that the bicycle helmet is intelligent by activating both the speed indicator 400 and the head angle indicator 500 to measure a speed of the bicycle and a pivot angle of the handlebar respectively. Further, the corresponding changes in both the speed indicator 400 and the head angle indicator 500 are converted into signals and sent to the MCU 200. Furthermore, the MCU 200 processes the signals to light or flash components of the LED device 100 for warning pedestrians and other vehicles in riding.

While the invention has been described in terms of preferred embodiments, those skilled in the art will recognize that the invention can be practiced with modifications within the spirit and scope of the appended claims.

What is claimed is:

1. A bicycle helmet apparatus, comprising:
a helmet;
a front left light assembly disposed on a left side of the helmet and including a plurality of front left turn signal lights and a plurality of front left indicators;
a front right light assembly disposed on a right side of the helmet and including a plurality of front right turn signal lights and a plurality of front right indicators;
a rear light assembly disposed on an upper portion of a rear end of the helmet and including a plurality of indicators;
a left light assembly disposed on a left side of a lower portion of the rear end of the helmet;
a right light assembly disposed on a right side of the lower portion of the rear end of the helmet;
a plurality of rear left turn signal lights disposed on an upper portion of the left light assembly;
a plurality of rear left brake lights disposed on a lower portion of the left light assembly;
a plurality of rear right turn signal lights disposed on an upper portion of the right light assembly;
a plurality of rear right brake lights disposed on a lower portion of the right light assembly;
a LED device including the rear light assembly, the rear left turn signal lights, the rear left brake lights, the rear right turn signal lights, the rear right brake lights, the front left turn signal lights, the front left indicators, the front right turn signal lights, and the front right indicators;
a microcontroller unit (MCU) disposed in the helmet and electrically connected to the LED device;
a power supply electrically connected to the MCU and including a rechargeable battery;
left and right buzzers electrically connected to the MCU;
a speed indicator electrically connected to the MCU; and
a head angle indicator electrically connected to the MCU.

2. The bicycle helmet apparatus of claim 1, further comprising a charging socket disposed on the rear end of the helmet and electrically connected to the rechargeable battery.

3. The bicycle helmet apparatus of claim 1, wherein the left and right buzzers are disposed on the rear end of the helmet.

4. The bicycle helmet apparatus of claim 1, further comprising a rear shell component disposed on the rear end of the helmet and left and right shell components disposed on left and right sides of the helmet respectively.

5. The bicycle helmet apparatus of claim 1, further comprising a pad member disposed on an inner surface of the helmet, two chin straps extending from the right and left sides of the helmet respectively, a female fastener disposed at an end of one chip strap, and a male fastener disposed at an end of the other chip strap and configured to insert into the female fastener to secure the chin straps together.

6. The bicycle helmet apparatus of claim 1, wherein the helmet is streamlined.

7. The bicycle helmet apparatus of claim 1, wherein the rear left turn signal lights, the rear right turn signal lights, the front left turn signal lights, and the front right turn signal lights are formed of yellow LEDs; the indicators, the rear left brake lights, and the rear right brake lights are formed of red LEDs; and the front left indicators and the front right indicators are formed of white LEDs respectively.
